(19) United States
(12) Patent Application Publication
(10) Pub. No.: US 2014/0092088 A1
(43) Pub. Date: Apr. 3, 2014

(54) PROVIDING A THREE-DIMENSIONAL VIEW THAT INCLUDES A PLURALITY OF SYSTEMS ENGINEERING MODELS

(71) Applicant: SIEMENS AKTIENGESELLSCHAFT, Munich (DE)

(72) Inventors: Peter Hutchison, Cambridge (GB); Dmitriy Okunev, Lawrenceville, NJ (US); Martin Witte, Schwabach (DE); Nicolai Plewinski, Roethenbach/Pegnitz (DE)

(73) Assignee: SIEMENS AKTIENGESELLSCHAFT, Munich (DE)

(21) Appl. No.: 13/644,029

(22) Filed: Oct. 3, 2012

(51) Int. Cl. G06T 17/00

(52) U.S. Cl. 345/420

(57) ABSTRACT

A three-dimensional view that includes a plurality of systems engineering models may be provided. A first systems engineering model and a second systems engineering model of the plurality of systems engineering models may be received. The three-dimensional view that includes the first systems engineering model and the second systems engineering model may be generated. The first systems engineering model may be projected onto a first plane of a three-dimensional coordinate system. The second systems engineering model may be projected onto a second plane of the three-dimensional coordinate system. The second plane is different than the first plane. The three-dimensional view may be displayed.

### BACKGROUND

The present embodiments relate to model-based systems engineering, and, in particular, providing a view that includes plurality of systems engineering models.

Model-based systems engineering is the application or utilization of modeling within or as part of a technical baseline that includes the requirements, design, verification, and analysis of a capability, system, and/or product throughout the life cycle of the capability, system, and/or product (i.e., from conception, through design and manufacture, to service and disposal). A series of models is typically developed, with each model representing one aspect—the requirements, design, verification, or analysis—of the technical baseline. Each model in the series of models is typically linked to one or more other models. For example, in an automotive adaptive cruise control, the requirement “maintain safe distance behind vehicle in front” may be linked to the function “control distance from vehicle in front.”

In known systems engineering modeling applications, the different models may be displayed in the user interface as side-by-side, but separate, views or screens or may be displayed in separate views or screens, one view or screen at a time. This makes linking elements or determining which model elements are linked together a complicated multi-step operation. When, for example, two models are displayed in side-by-side, but separate, views or screens in the user interface, a user must resort to a complex sequence of textual selection in order to link the elements of the models or determine which elements of the models are linked together. When, however, the user interface individually displays models (i.e., one view or screen at a time), the user of the user interface must switch between the different views or screens to link the elements of the models or determine which elements of the models are linked together. In either case, this process is complicated and time-consuming, particularly when a number of elements in the two models are linked or need to be linked to one another.

### BRIEF SUMMARY

To address these and other objectives, the present embodiments relate to a system, method, and computer-readable media for providing a three-dimensional view that includes a plurality of systems engineering models. Different models are projected onto different planes represented by the three-dimensional view. The present invention is defined by the following claims, and nothing in this section should be taken as a limitation on those claims.

In a first aspect, a system is provided for providing a three-dimensional view that includes a plurality of systems engineering models. The system includes a modeling device and a graphical modeling application operable on the modeling device. The graphical modeling application is configured to obtain a first systems engineering model and a second systems engineering model of the plurality of systems engineering models. The graphical modeling application is configured to generate, on a display, the three-dimensional view that includes the first systems engineering model and the second systems engineering model. The first systems engineering model is projected onto a first plane of a three-dimensional coordinate system and the second systems engineering model is projected onto a second plane of the three-dimensional coordinate system. The second plane is different than the first plane.

In a second aspect, a method is provided for providing a three-dimensional view that includes a plurality of systems engineering models. The method includes receiving a first systems engineering model and a second systems engineering model of the plurality of systems engineering models. The method also includes generating the three-dimensional view that includes the first systems engineering model and the second systems engineering model. Generating includes projecting the first systems engineering model onto a first plane of a three-dimensional coordinate system and projecting the second systems engineering model onto a second plane of the three-dimensional coordinate system. The second plane is different than the first plane. The method further includes displaying the three-dimensional view.

In a third aspect, a non-transitory computer-readable storage medium has stored therein data representing instructions executable by a programmed processor for displaying a plurality of systems engineering models in a three-dimensional view. The storage medium comprises instructions for projecting a first model onto a first plane of a three-dimensional coordinate system and projecting a second model onto a second plane of the three-dimensional coordinate system. The second plane is different than the first plane. The second model is different than the first model, but the first and second models represent related objects or elements. The storage medium further comprises instructions for displaying the three-dimensional view as the projections onto the first and second planes.

Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of a system for providing a three-dimensional view that includes a plurality of systems engineering models;

FIG. 2 illustrates one embodiment of a requirements model;

FIG. 3 illustrates one embodiment of a functional model;

FIG. 4 illustrates one embodiment of a logical model;

FIG. 5 illustrates one embodiment of a three-dimensional view of a plurality of systems engineering models;

FIG. 6 illustrates one embodiment of a three-dimensional view that includes the functional model of FIG. 3 and the logical model of FIG. 4;

FIG. 7 illustrates one embodiment of a three-dimensional view that includes the requirements model of FIG. 2, the functional model of FIG. 3, and the logical model of FIG. 4;

FIG. 8 illustrates another embodiment of a three-dimensional view of a plurality of systems engineering models; and

FIG. 9 is a flow chart diagram of one embodiment of a method for providing a three-dimensional view that includes a plurality of systems engineering models.

### DETAILED DESCRIPTION OF THE DRAWINGS AND PRESENTLY PREFERRED EMBODIMENTS

The present embodiments relate to a method, system, and computer-readable media for providing a three-dimensional view that includes a plurality of systems engineering models. First and second systems engineering models of the plurality of systems engineering models may be received or obtained. The three-dimensional view, including the first and second systems engineering models, may be generated, with the first systems engineering model projected onto a first plane of a three-dimensional coordinate system and the second systems engineering model projected onto a second plane of the three-dimensional coordinate system. The second plane is different from the first plane. The generated three-dimensional view may then be displayed or provided.

By providing or displaying different systems engineering models in the same three-dimensional coordinate system, the present embodiments may allow a user of a user interface to (i) quickly and easily view or switch between different systems engineering models and elements or objects of the different systems engineering models, (ii) quickly and easily browse or view pre-defined relationships or connections between the elements or objects of the different systems engineering models, (iii) navigate to a particular systems engineering model, navigate to particular elements or objects within a particular systems engineering model, and/or navigate to a particular relationship or connection between elements or objects of different systems engineering models, and/or (iv) quickly and easily configure or define relationships or connections between elements or objects of different systems engineering models. The user may no longer need to resort to cumbersome and complex textual selection and/or switching between different views or screens in the user interface to accomplish any of these objectives, as is the case in known systems engineering modeling applications. Accordingly, the present embodiments may enhance the usability and reduce the complexity of the user interface.

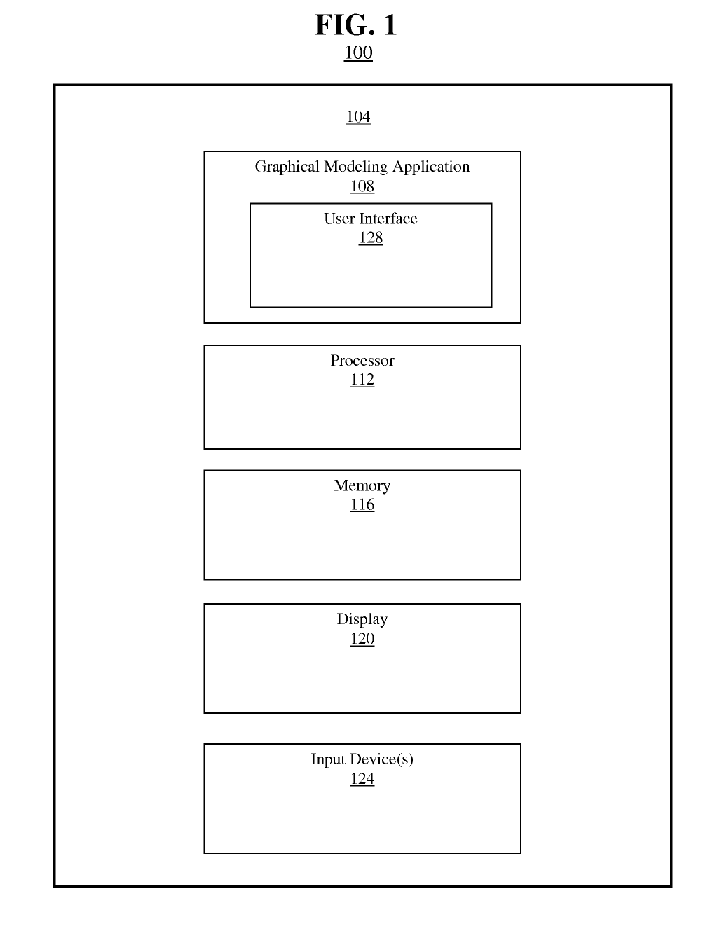

FIG. 1 depicts a system 100 for providing a plurality of systems engineering models in a three-dimensional view. The system 100 includes a modeling device 104 and a graphical modeling application 108 operable on the modeling device 104. In other embodiments, the system 100 may include additional, different, or fewer components. For example, additional modeling devices 104 and/or graphical modeling applications 108 may be provided.

The modeling device 104 may be a computer (e.g., a desktop or a notebook), a workstation, a mobile device (e.g., a smart phone), a server, or other processing device. The modeling device 104 generally includes a processor 112, a memory 116, a display 120, and one or more input devices 124. In other embodiments, the modeling device 104 may include additional, different, or fewer components.

The processor 112 may be a general processor, a digital signal processor, ASIC, field programmable gate array, analog circuit, digital circuit, combinations thereof, or other now known or later developed processor.

The memory 116 may be a volatile memory or a non-volatile memory. The memory 116 may include one or more of a read only memory (ROM), random access memory (RAM), a flash memory, an electronic erasable program read only memory (EEPROM), or other type of memory. The memory 116 may include an optical, magnetic (hard drive) or any other form of data storage device.

The display 120 is generally configured to display, provide, or present a three-dimensional model, generated or created by the graphical modeling application 108, that includes the plurality of systems engineering models. The display 120 may be a liquid crystal display (LCD) panel, light-emitting diode (LED) screen, thin film transistor screen, cathode ray tube (CRT), or any other type of display.

The one or more input devices 124 may include one or more buttons, a keypad, a mouse, a stylist pen, a rocker switch, a touch pad, sliders, a touch screen, or other input device for manipulating the three-dimensional model generated or created by the graphical modeling application 108.

The graphical modeling application 108 is, as noted above, operable on the modeling device 104. The graphical modeling application 108 includes a graphical user interface 128. The graphical modeling application 108 may be stored on one or more hard drive(s), cache, RAM, or other computer-readable media operated by the modeling device 104 and loaded into the memory 116 of the modeling device 104 to be executed by the processor 112.

The graphical modeling application 108 may be any type of software application configured to provide or display a three-dimensional model that includes the plurality of systems engineering models in a three-dimensional view. The graphical modeling application 108 may utilize any number of different modeling languages, such as, for example, Java, Unified Modeling Language (UML), or SysML. In one embodiment, the graphical modeling application 108 is an ECLIPSE-based graphical modeling application (ECLIPSE is an open source community whose projects are focused on building an open development platform comprised of extensible frameworks, tools, and runtimes for building, deploying, and managing software across the lifecycle). In such an embodiment, the graphical modeling application 108 may utilize the ECLIPSE Graphical Editing Framework (GEF) and includes GEF3D, which comprises a series of ECLIPSE plug-ins. GEF 3D is based on (e.g., is an extension of) the ECLIPSE GEF and generally supports a three-dimensional display or view in which a plurality of GEF diagrams or models may be shown. In one embodiment, the graphical modeling application 108 is part of Teamcenter, an integrated suite of Product Lifecycle Management applications available from Siemens PLM Software. In another embodiment, the graphical modeling application 108 is part of NX, an integrated suite of computer-aided design, manufacturing, and engineering applications, also available from Siemens PLM Software. In other embodiments, the graphical modeling application 108 may be a different type of graphical modeling application.

The graphical modeling application 108 is generally configured to receive or obtain the plurality of systems engineering models. The plurality of systems engineering models are user-defined, created, or generated using or via the user interface 128 of the graphical modeling application 108, using or via a user interface of another graphical modeling application, using or via a user interface of another modeling device 104, or combinations thereof. Alternatively or additionally, the models are uploaded, obtained from memory, or received in a transfer over a network.

In general, each systems engineering model represents a different aspect of the capability, system, product, or product line. Often, the systems engineering models represent the capability, system, product, or product line in a different design phase or at a different level of abstraction. Accordingly, one or more of the systems engineering models may be at a different (e.g., higher) level of abstraction than one or more other systems engineering models. The plurality of systems engineering models may include one or more requirements models, one or more functional models, one or more system architecture models, one or more behavioral models, one or more models of test cases, one or more models of use cases, one or more logical models, one or more physical models, other systems engineering models, or combinations thereof. One of more of the plurality of systems engineering models may be a hybrid of multiple types of models. Each systems engineering model of the plurality of systems engineering models may include a plurality of objects or elements, as will be described in further detail below.

In some embodiments, one or more systems engineering models may be linked, connected, or related to, or otherwise associated with, one or more other systems engineering models. In other words, a relationship between one or more systems engineering models and one or more other systems engineering models may already be defined (i.e., the relationship is pre-defined). Any number of relationships may be pre-defined between systems engineering models. More specifically, one or more elements or objects (i.e., one or more source objects or elements) of the one or more engineering models may be linked, connected, allocated, traced, or related to, or otherwise associated with, one or more elements or objects (i.e., one or more target objects or elements) of the one or more other engineering models. A relationship between one or more source elements or objects of the one or more systems engineering models and one or more target elements or objects of the one or more other systems engineering models may be pre-defined. For example, one source object or element of a first systems engineering model may be linked with one target object or element of a second systems engineering model. Any number of relationships may be pre-defined. In one embodiment, the relationship represents a flow (e.g., energy, matter, information, parts, or any other physical or logical quantity) between one or more source elements or objects of the one or more systems engineering models and one or more target elements or objects of the one or more other systems engineering models. The relationship(s) may be represented by a line, an arrow, or some other connector. The relationship(s) described in this paragraph is (are) defined, before a three-dimensional view of the plurality of systems engineering models is generated, using or via the user interface 128 of the graphical modeling application 108, using or via a user interface of another graphical modeling application, using or via a user interface of another modeling device 104, during creation one of the models, based on user input, automatically, based on relationship knowledge, or combinations thereof

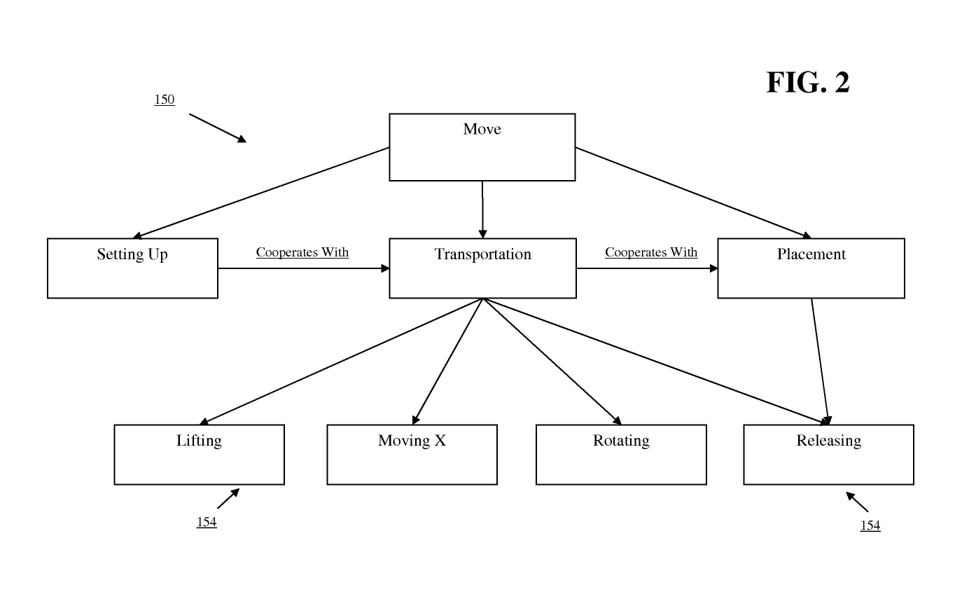

FIG. 2 depicts an exemplary requirements model 150 that may be received, created, or obtained by or using the graphical modeling application 108. The requirements model 150 generally represents or depicts the requirements in the capability, system, and/or product life cycle, or portions thereof (e.g., the design phase, the manufacturing phase, etc.). The requirements model 150 includes a plurality of objects or elements 154 arranged in a hierarchy, a block diagram, or in some other way. Each object or element represents an operational, functional, or non-functional requirement in the requirements model 150. Each object or element 154 may be related to, or otherwise associated with, at least one other object or element in the requirements model 150. The requirements model 150 may include one or more narratives or captions that are associated with and describe or explain a respective relationship between two objects or elements 154.

In the embodiment shown in FIG. 2, the requirements model 150 includes the following requirements: “move,” “setting up,” “transportation,” “placement,” “lifting,” “moving X,” “rotating,” and “releasing” arranged in a hierarchy. The requirements model 150 includes the narrative “correlates with” between the “setting up” requirement and the “transportation” requirement, indicating that the “setting up” requirement is correlated with the “transportation” requirement. The requirements model 150 also includes the narrative “correlates with” between the “transportation” requirement and the “placement” requirement, indicating that the “transportation” requirement is correlated with the “placement” requirement. In other embodiments, the plurality of objects or elements 154 may be arranged differently, the requirements model 150 may include additional, different, or fewer requirements, objects or elements, the requirements model 150 may include additional, different, or fewer narratives or captions between the requirements, or combinations thereof

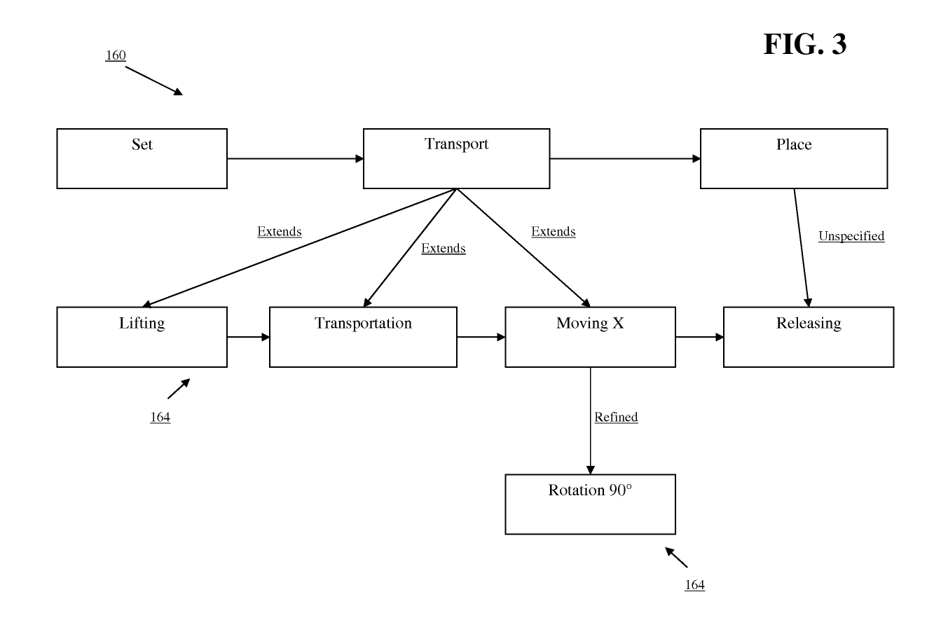

FIG. 3 depicts an exemplary functional model 160 that may be received, created, or obtained by or using the graphical modeling application 108. The functional model 160 generally represents different functions (e.g., activities, actions, processes, operations) within the life cycle of the capability, system, and/or product, or portions thereof. The functional model 160 includes a plurality of objects or elements 164 arranged in a hierarchy, a block diagram, N2 chart, or in some other way. Each object or element represents a function (e.g., activity, action, process, operation) in the functional model 160. Each object or element 164 may be related to, or otherwise associated with, at least one other object or element in the functional model 160. The functional model 160 may include one or more narratives or captions that are associated with and describe or explain a relationship between two objects or elements 160.

In the embodiment shown in FIG. 3, the functional model 160 includes the following functions: “set,” “transport,” “place,” “lift up,” “move X,” “rotate,” “place down,” and “rotation 90° ” arranged in a hierarchical block diagram. The functional model 160 includes the narrative “extends” between the “transport” function and the “lift up,” “move X,” and “rotate” functions, indicating that the “transport” function or activity may be extended to produce or result in lifting up, moving, and/or rotating X. The functional model 160 further includes the narrative “refined” between the “rotate” and “rotation 90° ” functions and the narrative ^{“}unspecified” between the “place” and the “place down” functions. In other embodiments, the plurality of objects or elements 164 may be arranged differently, the functional model 160 may include additional, different, or fewer functions, objects, or elements, the functional model 160 may include additional, different, or fewer narratives or captions between the functions, or combinations thereof

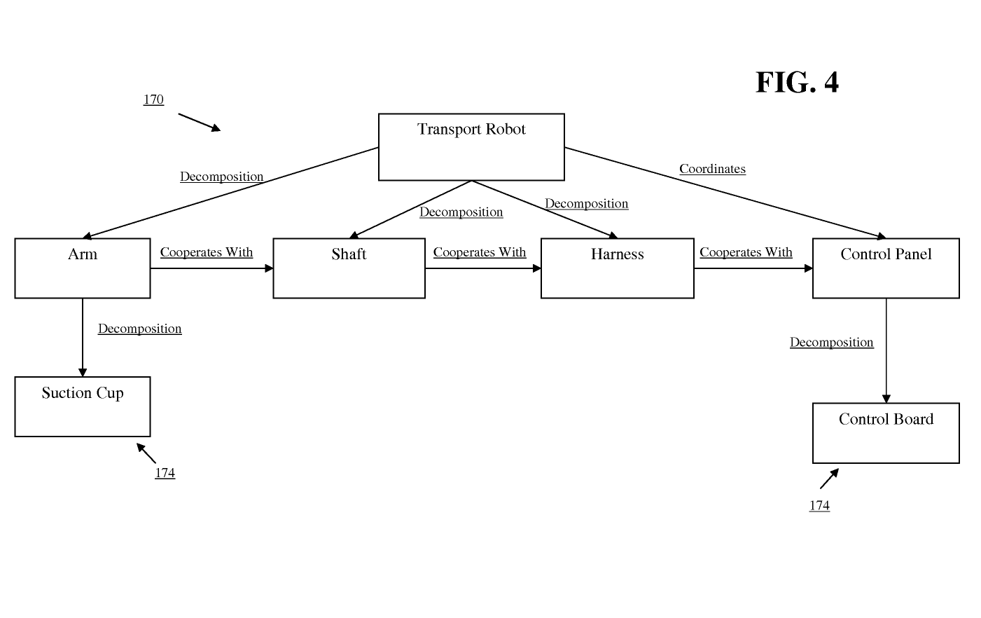

FIG. 4 depicts an exemplary logical model 170 that may be received or obtained by the graphical modeling application 108. The logical model 170 generally represents or depicts the components or parts in the capability, system, and/or product that may interact to satisfy the requirements. The logical model 170 includes a plurality of objects or elements 174 arranged in a hierarchy, a block diagram, or in some other way. Each object or element 174 represents a component or part in the logical model 170. Each object or element 174 may be related to, or otherwise associated with, at least one other object or element in the logical model 170. The logical model 170 may include one or more narratives or captions that are associated with and describe or explain a respective relationship between two objects or elements 174.

In the embodiment shown in FIG. 4, the logical model 170 includes the following components or parts: “transport robot,” “arm,” “shaft,” “harness,” “control panel,” “suction cup,” and “control board” arranged in a hierarchical block diagram. The logical model 170 includes the narrative “decomposition” between the “arm” and the “suction cup” and between the “control panel” and the “control board,” indicating that the suction cup is part of the arm and the control board is part of the control panel. The logical model 170 includes other narratives, such as “cooperates with,” and “coordinates,” as shown in FIG. 4. In other embodiments, the plurality of objects or elements 174 may be arranged differently, the logical model 170 may include additional, different, or fewer components or parts, objects, or elements, the logical model 170 may include additional, different, or fewer narratives or captions between the components or parts, or combinations thereof

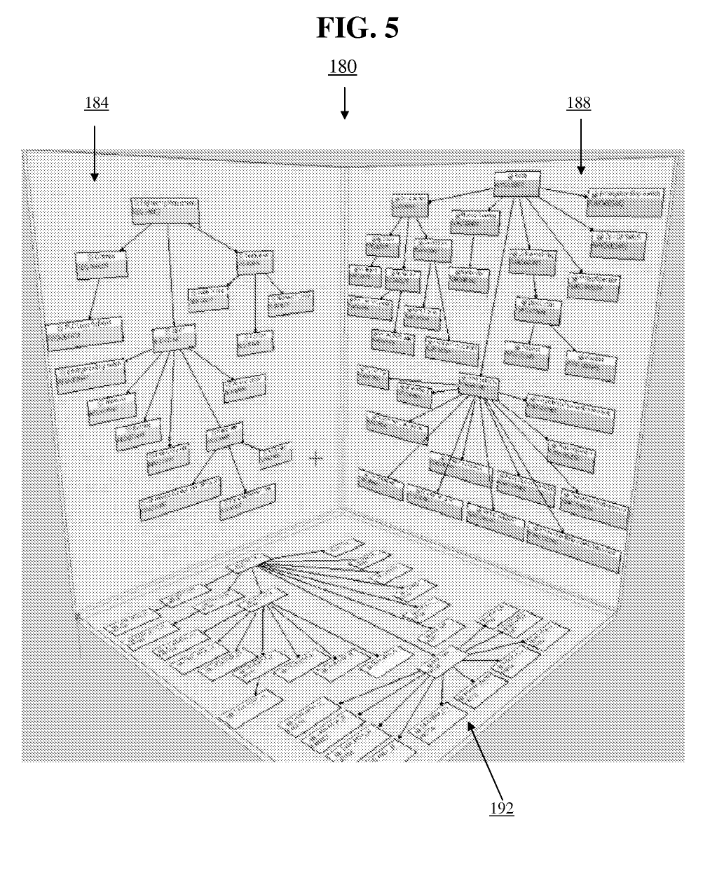

Once the graphical modeling application 108 has received the plurality of systems engineering models, such as, for example, the requirements model 150, the functional model 160, and the logical model 170, the graphical modeling application 108 is configured to generate or create a three-dimensional view 180, depicted in FIG. 5, that includes or depicts the systems engineering models in a three-dimensional coordinate system. To this end, the graphical modeling application 108 is configured to project a first systems engineering model 184 of the plurality of systems engineering models onto a first plane of the three-dimensional coordinate system and to project a second systems engineering model 188 of the plurality of systems engineering models onto a second plane of the three-dimensional coordinate system, as shown in FIG. 5. The second plane is different from the first plane. The graphical modeling application 108 is, in this embodiment, further configured to project a third systems engineering model 192 onto a third plane of the three-dimensional coordinate system. The third plane is different from the first plane and the second plane. The graphical modeling application 108 may, in other embodiments, be configured to project additional systems engineering models onto respective additional planes of the three-dimensional coordinate system. The additional planes are different from the first, second, and third planes.

The three-dimensional view or representation may be any type of three-dimensional view (e.g., “birds eye” perspective view, front perspective view, etc.). The three-dimensional view may be rendered to a two-dimensional display by projection rendering, surface rendering, and/or texture mapping. Shading, opacity (transparency), transfer function, and/or lighting may be used in rendering to provide a desired view without obstructing some or all information to be represented in the three-dimensional view.

The three-dimensional coordinate system is a three-dimensional Cartesian coordinate system with an x-axis, a y-axis, and a z-axis. Accordingly, the first plane, second plane, third plane, and any additional planes are projected or oriented relative to the x-axis, y-axis, and the z-axis. The first plane, second plane, third plane, and any additional planes may be an xy plane (z=0), a yz plane (x=0), an xz plane (y=0), any other plane, or combinations thereof. The first plane, second plane, third plane, and any additional planes may be parallel to one or more of the other planes, perpendicular to one or more of the other planes, arranged or oriented differently (i.e., not parallel or perpendicular to one or more of the other planes), or combinations thereof. In one embodiment, the first plane, second plane, and third plane may each be an xy plane, yz plane, or xz plane, and are parallel to one another. In another embodiment, the first plane is an xy plane, the second plane is a yz plane, and the third plane is xz plane, such that the first plane, the second plane, and the third plane are all perpendicular to one another. In other embodiments, polar coordinates or other three-dimensional coordinate systems may be used.

In the embodiments in which the one or more source elements or objects of the one or more systems engineering models are related to, or otherwise associated with, one or more target elements or objects of the one or more other systems engineering models before the three-dimensional view is generated or created, the relationship(s) or association(s) is (are) included in the three-dimensional view. In other embodiments, the one or more source elements or objects of the one or more systems engineering models may be related to, or otherwise associated with, one or more target elements or objects of the one or more other systems engineering models after the three-dimensional view has been generated or created and displayed. In these embodiments, after the three-dimensional view has been generated or created and displayed in the user interface 128 on the display 120 of the modeling device 104, the user of the user interface 128 may define the relationship(s), or association(s). In one embodiment, each relationship or association may be defined by moving the input device 124 to a source element or object of one systems engineering model, selecting or clicking on the source element or object, moving the input device 124 from the source element or object to a target element or object of a different systems engineering model, and selecting or clicking on the target element or object. In another embodiment, each relationship or association may be defined in another way, such as, for example, typing or entering, via the input device 124 (e.g., a keypad), the desired relationship or association. In turn, relationship(s) may be displayed in the graphical user interface 128 on the display 120. As noted above, the relationship(s) may be represented by a line (e.g., a colored line), an arrow, or some other connector.

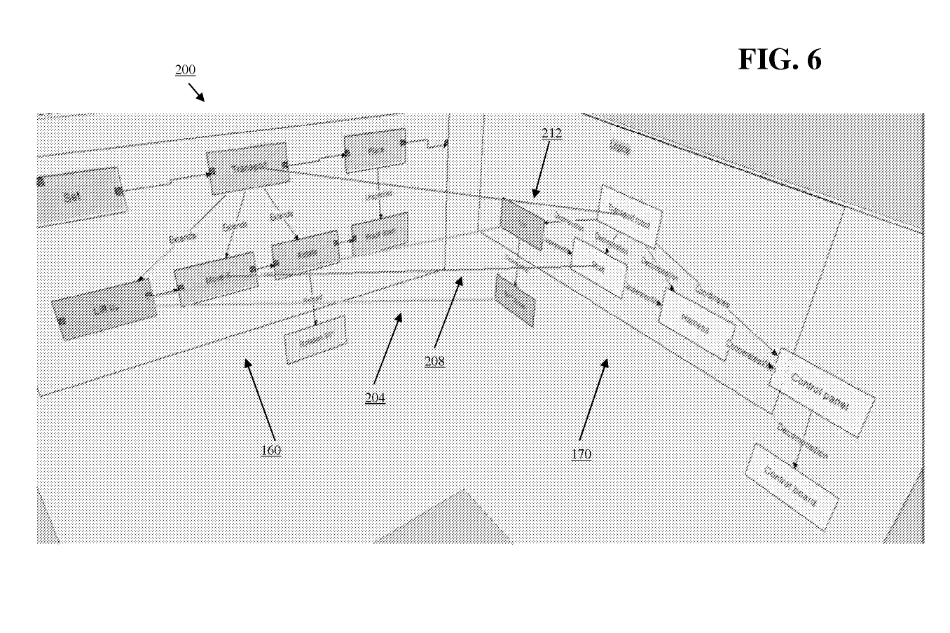

FIG. 6 illustrates an exemplary three-dimensional view 200 generated or created by the graphical modeling application 108. The three-dimensional view 200 is a perspective view of the three-dimensional Cartesian coordinate system described above. The view 200 includes or depicts the functional model 160 projected onto a yz plane (x=0) and the logical model 170 projected onto an xz plane (y=0) in the three-dimensional Cartesian coordinate system. As shown in FIG. 6, the functional model 160 is linked or connected with the logical model 170 via connectors or tracers 204, 208, 212. Each of the connectors or tracers 204, 208, 212 connects or links one element 164 of the functional model 160 with one element 174 of the logical model 170. The connectors or tracers 204, 208, 212 may, as noted above, be defined before or after the three-dimensional view 200 is generated or created. In other embodiments, additional, different, or fewer connectors or tracers may connect or link the functional model 160 with or to the logical model 170.

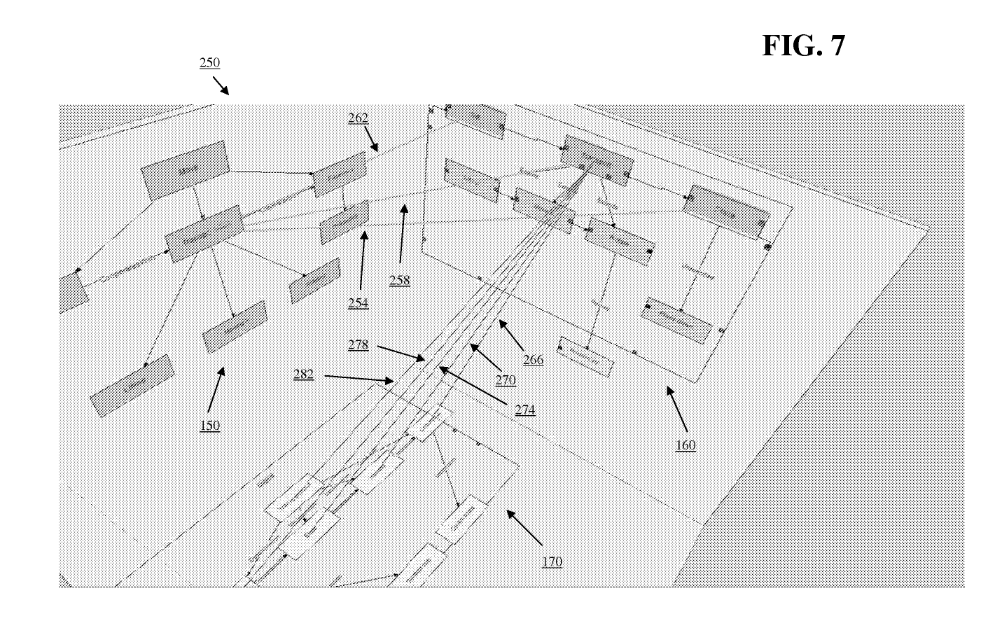

FIG. 7 illustrates another exemplary three-dimensional view 250 generated or created by the graphical modeling application 108. The three-dimensional view 250 is a perspective view of the three-dimensional Cartesian coordinate system described above. The view 250 includes or depicts the requirements model 150 projected onto a yz plane (x=0), the logical model 170 projected onto an xy plane (z=0), and the functional model 160 projected onto an xz plane (y=0). The systems engineering models in the view 250 are thus perpendicular to one another, such that the systems engineering models are oriented or arranged to form an “open corner” as shown in FIG. 7. As shown in FIG. 7, the requirements model 150 is linked or connected with the functional model 160 via connectors or tracers 254, 258, 262, and the functional model 160 is linked or connected with the logical model 170 via connectors or tracers 266, 270, 274, 278, 282. The connectors or tracers 254, 258, 262 are, at one end, connected to an element 154 of the requirements model 150, and are, at another end, connected to respective different elements 164 of the functional model 160. The connectors or tracers 266, 270, 274, 278, 282, are, at one end, connected to an element 164 of the functional model 160, and are, at another end, connected to respective different elements 174 of the logical model 170. The connectors or tracers 258, 262, 266, 270, 274, 278, 282, may be defined before or after the three-dimensional view 250 is generated or created. In other embodiments, additional, different, or fewer connectors or tracers may connect or link the requirements model 150, the functional model 160, the logical model 170, or combinations thereof, together.

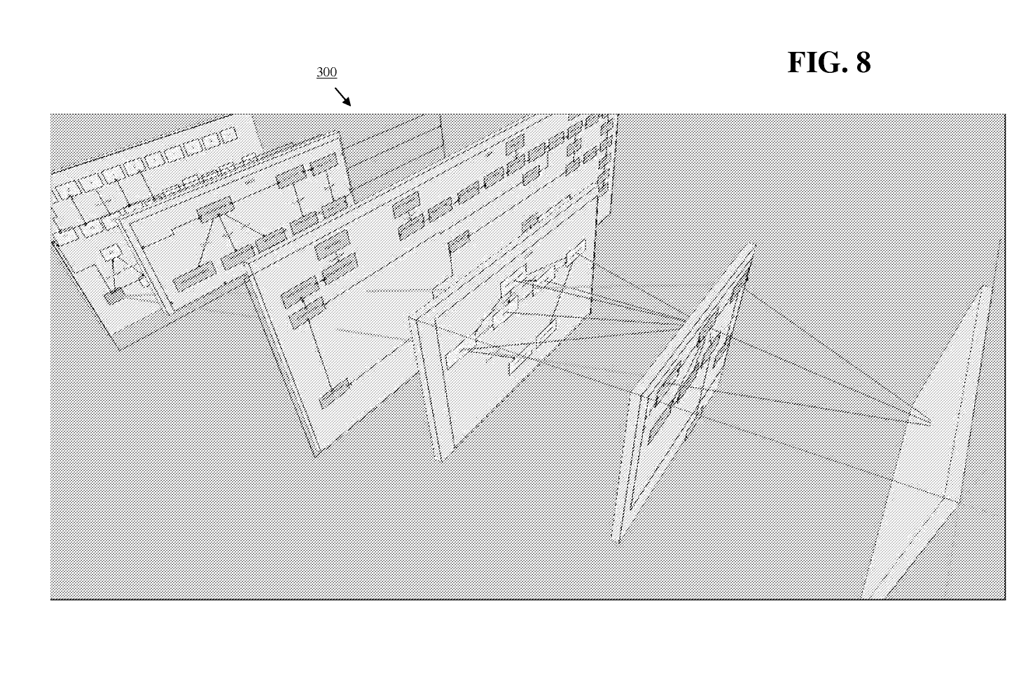

FIG. 8 illustrates yet another exemplary three-dimensional view 300 generated or created by the graphical modeling application 108. The three-dimensional view 300 is a perspective view of the three-dimensional Cartesian coordinate system described above. The view 300 includes a plurality of systems engineering models, such as the requirements model 150, the functional model 160, the logical model 170, and/or other models, each projected onto a different yz plane (x=0). The systems engineering models in the view 300 are thus parallel to one another, such that the systems engineering models are oriented or arranged in a “stacked” arrangement as shown in FIG. 8. Any spacing between models or planes and/or relative scaling of the models may be used.

Once the graphical modeling application 108 generates or creates the three-dimensional view (e.g., view 200, view 250, view 300, or other view), the three-dimensional view may be provided or displayed in the graphical user interface 128 on the display 120 of the modeling device 104. In turn, the user of the user interface 128 may modify, adjust, or alter the three-dimensional view (or the components therein). As noted above, the user may define inter-model relations or connections between two or more systems engineering models. The user may also navigate to a particular systems engineering model, or a portion thereof (e.g., one or more elements of a particular systems engineering model) by zooming in or out of the three-dimensional view, rotating or re-orienting the three-dimensional view, selecting one or more particular systems engineering models (or one or more elements or objects therein), or combinations thereof, using the one or more input devices 124. In one embodiment, the user may, using the one or more input devices 124, select one or more specific elements of a particular systems engineering model. In response, the graphical modeling application 108 may automatically highlight one or more specific elements of a different systems engineering model that are connected to or linked with the selected one or more elements. The user may also, in some embodiments, select and edit one or more specific elements of a particular systems engineering model. For example, the user may edit a requirement that says “move” so that it reads “move to X.”

Furthermore, the user may filter the three-dimensional view (e.g., view 200, view 250, view 300, or other view) based on one or more specific systems engineering models, one or more specific elements or objects in a specific systems engineering model, one or more relationships or associations between elements or objects, or combinations thereof. The “filtered” systems engineering models, elements or objects, relationships or associations, or combinations thereof, may, in turn, be removed from or turned off (i.e., not visible) in the three-dimensional view. For example, with reference to FIG. 6, the user may filter the three-dimensional view 200 based on the three objects or elements 164 of the functional model 160 that are connected or linked with or to the logical model 170. In turn, the remaining elements or objects 164 of the functional model 160 and the elements or objects 174 of the logical model 170 that are not connected to the three objects or elements 164 may be removed from or turned off (i.e., not visible) in the three-dimensional view 200. Filtering may alternatively lead to relative highlighting, such as rendering the selected elements more opaque, bright, or lit relative to the filtered out elements.

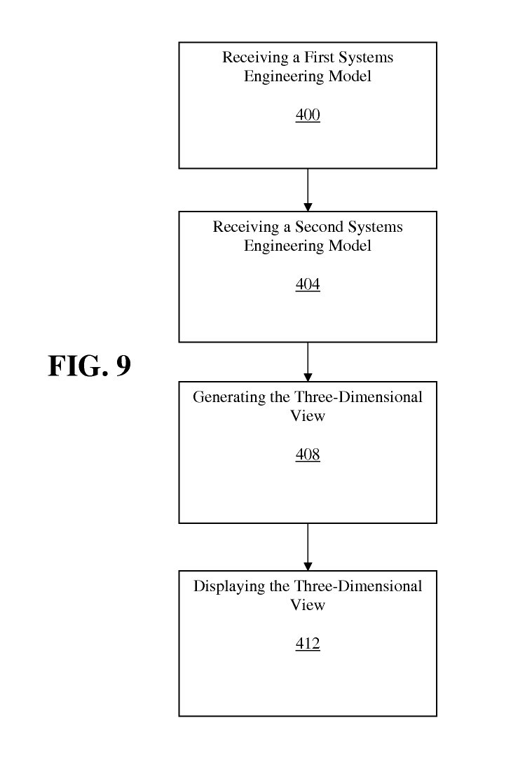

Referring to FIG. 9, there is shown a flow chart depicting the operation of a system for providing a three-dimensional view that includes a plurality of systems engineering models. The operation may be implemented using the system 100 described above. In other embodiments, a different system may be used. The method is implemented in the order shown, but may be implemented in or according to any number of different orders. Additional, different, or fewer acts may be provided. For example, any number of additional, different systems engineering models (i.e., third, fourth . . . systems engineering models) may be received or obtained. As another example, a given model may be separated into parts, each being handled as a separate model (e.g., two functional models rendered to different planes of the three-dimensional view).

The operation or method includes receiving or obtaining a first systems engineering model of a plurality of systems engineering models (act 400) and receiving or obtaining a second systems engineering model of the plurality of systems engineering models (act 404). The first systems engineering model and the second systems engineering model are received or obtained at, via, or by a graphical modeling application. The plurality of systems engineering models are user-defined, created, or generated using or via a user interface of the graphical modeling application, using or via another graphical modeling application, or combinations thereof. The systems engineering models each generally represent a different aspect of a capability, system, product, or product line. The plurality of systems engineering models may include one or more requirements models, one or more functional models, one or more system architecture models, one or more behavioral models, one or more models of test cases, one or more models of use cases, one or more logical models, one or more physical models, other systems engineering models, or combinations thereof. Each systems engineering model of the plurality of systems engineering model may include a plurality of objects or elements. In some embodiments, one or more elements or objects of the first systems engineering model may be connected, related, traced, allocated, or linked to, or otherwise associated with, one or more elements or objects of the second systems engineering model. Any number of relationships (e.g., connections, tracings, allocations, links) or associations may be defined. The relationship(s) or association(s) may be defined before the systems engineering models are received or obtained, may be defined after the systems engineering models have been received or obtained (and after the three-dimensional view has been generated), or combinations thereof

The operation or method also includes generating the three-dimensional view including the first systems engineering model and the second systems engineering model (act 408). Generating the three-dimensional view includes projecting the first systems engineering model onto a first plane of a three-dimensional coordinate system and projecting the second systems engineering model onto a second plane of the three-dimensional coordinate system. The three-dimensional view or representation may be any type of three-dimensional view (e.g., “birds-eye” perspective view, front perspective view, etc.).

The three-dimensional coordinate system is a three-dimensional Cartesian coordinate system with an x-axis, a y-axis, and a z-axis. Accordingly, the first plane, second plane, and any additional planes are projected or oriented relative to the x-axis, y-axis, and the z-axis. The first plane, second plane, and any additional planes may be an xy plane (z=0), a yz plane (x=0), an xz plane (y=0), any other plane, or combinations thereof. In other embodiments, polar coordinate or other coordinate systems may be used. The first plane, second plane, and any additional planes may be parallel to one or more of the other planes, perpendicular to one or more of the other planes, arranged or oriented differently (i.e., not parallel or perpendicular to one or more of the other planes), or combinations thereof. As noted above, one or more elements or objects of the first systems engineering model may be related to or otherwise associated with, one or more elements or objects of the second systems engineering model. The relationship(s) or association(s) may be defined after the three-dimensional view has been generated.

The operation or method further includes displaying the three-dimensional view (act 412). The three-dimensional view may be displayed on a display of a modeling device, such as the modeling device 104. In some embodiments, the three-dimensional view may be transmitted or sent to a modeling device different from the one in which the graphical modeling application is running on and the three-dimensional view may be subsequently displayed on that modeling device.

The modeling device performs various acts described herein. The modeling device has a processor configured by instructions for providing a three-dimensional view that includes a plurality of systems engineering models. A non-transitory computer readable storage medium stores data representing instructions executable by the programmed processor. The instructions for implementing the processes, methods and/or techniques discussed herein are provided on non-transitory computer-readable storage media or memories, such as a cache, buffer, RAM, removable media, hard drive or other computer readable storage media. Non-transitory computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone, or in combination. Likewise, processing strategies may include multiprocessing, multitasking, parallel processing, and the like.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The processor is a general processor, central processing unit, control processor, graphics processor, digital signal processor, three-dimensional rendering processor, image processor, application specific integrated circuit, field programmable gate array, digital circuit, analog circuit, combinations thereof, or other now known or later developed device. The processor is a single device or multiple devices operating in serial, parallel, or separately. The processor may be a main processor of a computer, such as a laptop or desktop computer, or may be a processor for handling some tasks in a larger system, such as a graphics processing unit (GPU). The processor is configured by instructions, design, hardware, and/or software to perform the acts discussed herein.

While the invention has been described above by reference to various embodiments, it should be understood that many advantages and modifications can be made without departing from the scope of the invention. It is therefore intended that the foregoing detailed description be regarded as illustrative rather than limiting, and that it be understood that it is the following claims, including all equivalents, that are intended to define the spirit and the scope of this invention.

We claim:

1. A system for providing a three-dimensional view that includes a plurality of systems engineering models, the system comprising:
a modeling device; and
a graphical modeling application operable on the modeling device and configured to:
obtain a first systems engineering model of the plurality of systems engineering models and a second systems engineering model of the plurality of systems engineering models; and
generate, on a display, the three-dimensional view that includes the first systems engineering model and the second systems engineering model, the first systems engineering model being projected onto a first plane of a three-dimensional coordinate system, and the second systems engineering model being projected onto a second plane of the three-dimensional coordinate system, the second plane being different than the first plane.

2. The system of claim 1, wherein the graphical modeling application utilizes an ECLIPSE Graphical Editing Framework (GEF).

3. The system of claim 2, wherein the graphical modeling application utilizes a three-dimensional ECLIPSE GEF based on the ECLIPSE GEF.

4. The system of claim 1, wherein each of the plurality of systems engineering models represents a different aspect of a system, capability, product, or product line.

5. The system of claim 1, wherein the plurality of systems engineering models comprises at least two of a requirements model, a functional model, a logical model, a physical model, and a system architectural model.

6. The system of claim 1, wherein the first plane is parallel to the second plane.

7. The system of claim 1, wherein the first plane is perpendicular to the second plane.

8. The system of claim 1, wherein the second systems engineering model is linked to the first systems engineering model.

9. The system of claim 1, wherein the three-dimensional view is a three-dimensional perspective view of the three-dimensional coordinate system.

10. The system of claim 1, wherein the first systems engineering model is at a first abstraction level and the second systems engineering model is at a second abstraction level different than the first abstraction level.

11. A method for providing a three-dimensional view that includes a plurality of systems engineering models, the method comprising:
receiving a first systems engineering model and a second systems engineering model of the plurality of systems engineering models;
generating, by a processor, the three-dimensional view including the first systems engineering model and the second systems engineering model, wherein generating comprises:
projecting the first systems engineering model onto a first plane of a three-dimensional coordinate system;
projecting the second systems engineering model onto a second plane of the three-dimensional coordinate system, the second plane being different than the first plane; and
displaying, on a display, the three-dimensional view.

12. The method of claim 11, further comprising:
defining a relationship between the first systems engineering model and the second systems engineering model;
displaying the relationship between the first systems engineering model and the second systems engineering model in the three-dimensional view.

13. The method of claim 12, wherein the relationship comprises a trace between an element of the first systems engineering model and an element of the second systems engineering model.

14. The method of claim 12, wherein defining the relationship comprises:
selecting, by an input device, an element of the first systems engineering model in the first plane;
moving the input device from the element of the first systems engineering model to the element of the second systems engineering model; and
selecting, by the input device, an element of the second systems engineering model in the second plane.

15. The method of claim 13, further comprising:
selecting, by an input device, the element of the first systems engineering model in the first plane; and
automatically highlighting, in response to the selecting, the element of the second systems engineering model.

16. The method of claim 12, wherein the first systems engineering model comprises a requirements model including a plurality of requirements, and wherein the second systems engineering model comprises a functional model including a plurality of functions, the method further comprising:
defining a trace between a specific requirement and a specific function; and
displaying the trace in the three-dimensional view.

17. In a non-transitory computer-readable storage medium having stored therein data representing instructions executable by a programmed processor for providing a three-dimensional view that includes a plurality of systems engineering models, the storage medium comprising instructions for:
projecting a first model onto a first plane of a three-dimensional coordinate system;
projecting a second model onto a second plane of the three-dimensional coordinate system, the second plane being different than the first plane, the second model being different than the first model, the first and second models representing related objects or elements; and
displaying the three-dimensional view as the projections onto the first and second planes.

18. The non-transitory computer-readable storage medium of claim 17, further comprising: projecting a third model onto a third plane of the three-dimensional coordinate system, the third plane being different than the first plane and the second plane, the third model is different than the first and second models, and wherein displaying comprises displaying the three-dimensional view as the projections onto the first, second, and third planes.

19. The non-transitory computer-readable storage medium of claim 18, wherein:
the first model comprises a requirements model,
the second model comprises a functional model, and
the third model comprises a logical model.

20. The non-transitory computer-readable storage medium of claim 18, wherein the first plane is an xy plane, the second plane is a yz plane, and the third plane is an xz plane.
